(19) United States
(12) Patent Application Publication
(10) Pub. No.: US 2014/0224362 A1
(43) Pub. Date: Aug. 14, 2014

(54) Connecting Structure of a Faucet Body and a Control Valve

(71) Applicant: Sen-Tien Shih, Changhua City (TW)

(72) Inventor: Sen-Tien Shih, Changhua City (TW)

(21) Appl. No.: 13/762,525

(22) Filed: Feb. 8, 2013

(51) Int. Cl. F16K 27/12

(52) U.S. Cl. CPC F16K 27/12
USPC 137/625.4

(57) ABSTRACT

A connecting structure of a faucet body and a control valve contains a faucet body, a fixing cylinder, a guiding seat, a control valve, and an outlet pipe. The faucet body includes a first segment, a second segment, a positioning rim, and a receiving space. The fixing cylinder is fitted into the faucet body and includes a circular cavity, an orifice, and two apertures. The guiding seat is disposed in the circular cavity and includes two grooves, two inlets. The control valve is inserted into the receiving space from the first segment of the faucet body, and a bottom end of the control valve is biased against the guiding seat. The outlet pipe couples with the faucet body and communicating with the guiding seat. Thereby, the guiding seat and the control valve are fixed in the faucet body, and a shape of the faucet body is geometrical and variable.

### BACKGROUND OF THE INVENTION

1. Field of the Invention

The present invention relates to a faucet, and more particularly to a connecting structure of a faucet body and a control valve that has variable aesthetics appearance and is manufactured at a low cost.

2. Description of the Prior Art

A conventional faucet is integrally formed from bronze material, but its internal waterway is so curved that cause poor quality, complicated manufacture, high production cost, defective products, heavy weight, and environmental pollution in bronze casting process. To improve such defects, a faucet body and an outlet pipe are separately made so that they are connected together after a copper bar is drilled and turned, yet such an improvement has expensive manufacture cost and troublesome working process. In addition, a shape of the faucet body is limited, such as a circular or a square shape.

Besides, some faucet bodies and output pipes are made of brass material, but these faucet bodies are circular without changing their shapes, and their thicknesses are so thin that the faucet bodies are coupled with the output pipes by using inner tubes and outer tubes, thus having high assembly cost. Furthermore, if the inner tubes cannot match with the outer tubes well, the inner tubes cannot be inserted into the outer tubes or the inner tubes cannot contact with internal walls of the outer tubes, thus having insecure assembly.

The present invention has arisen to mitigate and/or obviate the afore-described disadvantages.

### SUMMARY OF THE INVENTION

The primary object of the present invention is to provide a connecting structure of a faucet body and a control valve in which a faucet body is stamped and welded from a metal piece and is formed in a hollow tube shape so as to match with a fixing cylinder including a circular cavity, such that a guiding seat and a control valve are fixed in the faucet body, and a shape of the faucet body is geometrical and variable, thus increasing aesthetics appearance.

Another object of the present invention is to provide a connecting structure of a faucet body and a control valve in which the faucet body is stamped and welded from the metal piece and is formed in a hollow tube shape so as to match with the fixing cylinder including the circular cavity, such that the guiding seat and the control valve are fixed in the faucet body, so an interior of the faucet body cannot be worked precisely, thus accelerating working process and lowering material and production costs.

A connecting structure of a faucet body and a control valve in accordance with the present invention contains:

a faucet body stamped and welded from a metal piece and formed in a hollow tube shape, the faucet body including a first segment, a second segment relative to the first segment, a positioning rim defined on an inner wall thereof between the first segment and the second segment, and a receiving space formed between the positioning rim and the first segment;

a fixing cylinder formed in a shape corresponding to a shape of an interior of the faucet body, the fixing cylinder being fitted into the receiving space from the first segment of the faucet body and retaining with the positioning rim and including a circular cavity, an orifice defined on an outer wall thereof and communicating with the circular cavity, and two apertures arranged on a bottom end thereof so as to insert two inlet pipes;

a guiding seat disposed in the circular cavity of the fixing cylinder and including two grooves defined on a top surface thereof, two inlets passing downwardly therealong and having two lower ends which connect with the two inlet pipes of the fixing cylinder;

a control valve inserted into the receiving space from the first segment of the faucet body, and a bottom end of the control valve being biased against the guiding seat;

an outlet pipe coupling with the faucet body and communicating with the outlet of the guiding seat.

### BRIEF DESCRIPTION OF THE DRAWINGS

FIG. 1 is a perspective view showing the exploded components of a connecting structure of a faucet body and a control valve in accordance with a first embodiment of the present invention.

FIG. 2 is a cross-sectional perspective view showing the assembly of a faucet body of the connecting structure of the faucet body and the control valve in accordance with the first embodiment of the present invention.

FIG. 3 is a cross-sectional perspective view showing the assembly of a fixing cylinder of the connecting structure of the faucet body and the control valve in accordance with the first embodiment of the present invention.

FIG. 4 is a perspective view showing the assembly of the connecting structure of the faucet body and the control valve in accordance with the first embodiment of the present invention.

FIG. 5 is a cross-sectional view showing the assembly of the connecting structure of the faucet body and the control valve in accordance with the first embodiment of the present invention.

FIG. 6 is a perspective view showing the exploded components of a connecting structure of a faucet body and a control valve in accordance with a second embodiment of the present invention.

FIG. 7 is a perspective view showing the assembly and operation of the connecting structure of the faucet body and the control valve in accordance with the second embodiment of the present invention.

FIG. 8 is a cross-sectional view showing the assembly of the connecting structure of the faucet body and the control valve in accordance with the second embodiment of the present invention.

FIG. 9 is a cross-sectional view showing the assembly of a faucet body and a fixing cylinder of a connecting structure of a faucet body and a control valve in accordance with a third embodiment of the present invention.

FIG. 10 is a cross-sectional view showing the assembly of a faucet body and a fixing cylinder of a connecting structure of a faucet body and a control valve in accordance with a fourth embodiment of the present invention.

FIG. 11 is a cross-sectional view showing the assembly of a faucet body and a fixing cylinder of a connecting structure of a faucet body and a control valve in accordance with a fifth embodiment of the present invention.

FIG. 12 is a cross sectional view showing the operation of a connecting structure of a faucet body and a control valve in accordance with a sixth embodiment of the present invention.

FIG. 13 is a cross sectional view taken along lines A-A of FIG. 12.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

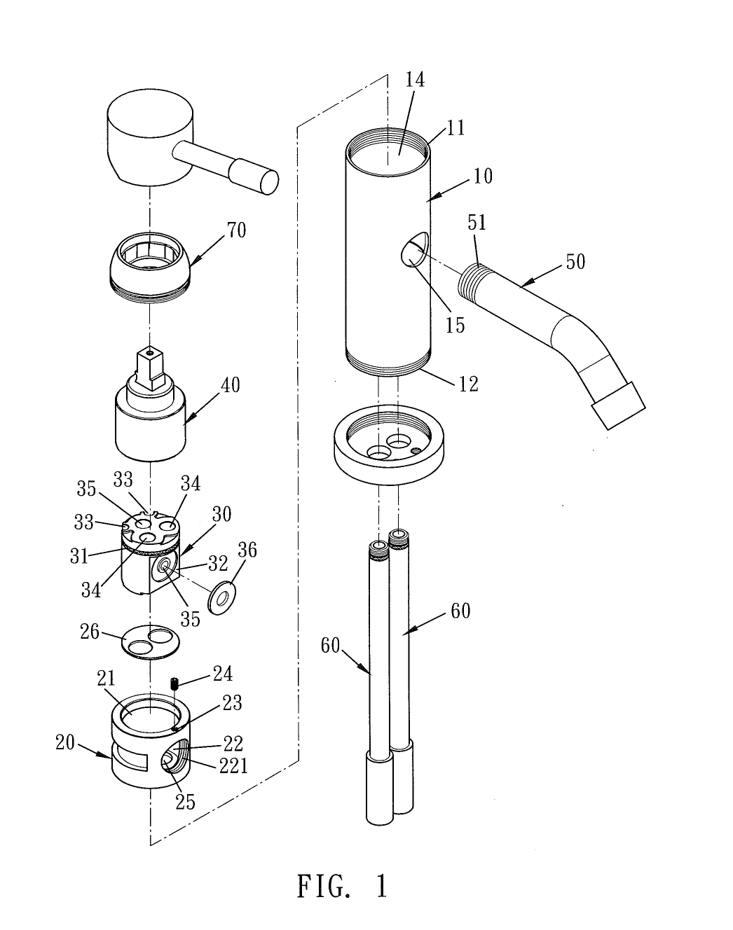

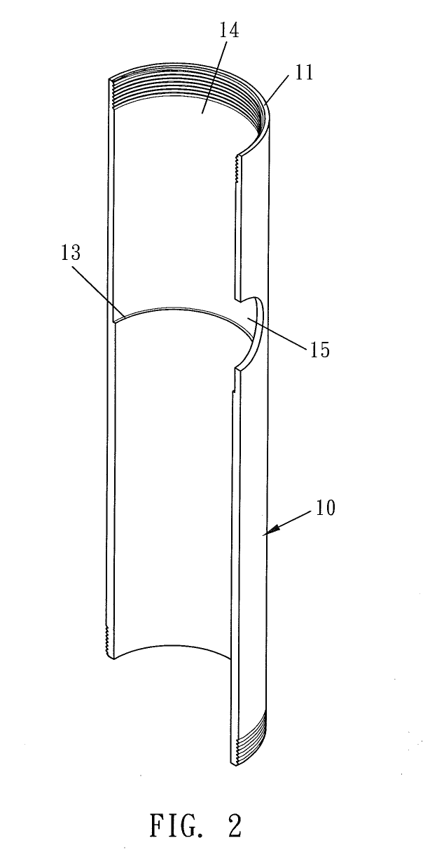

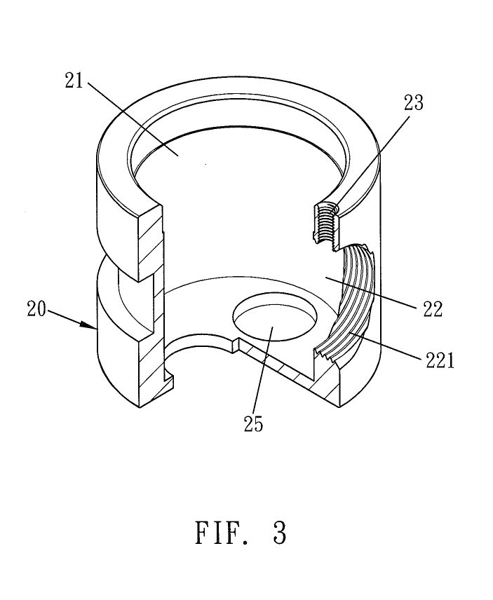

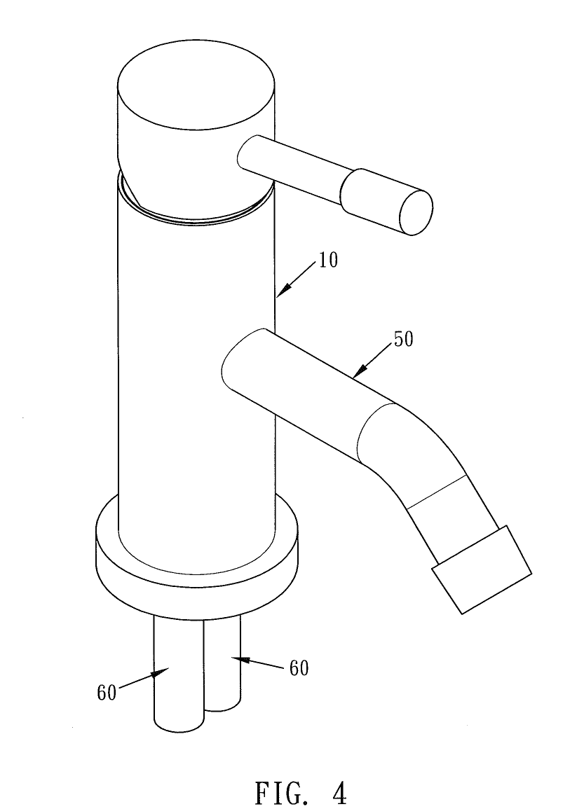

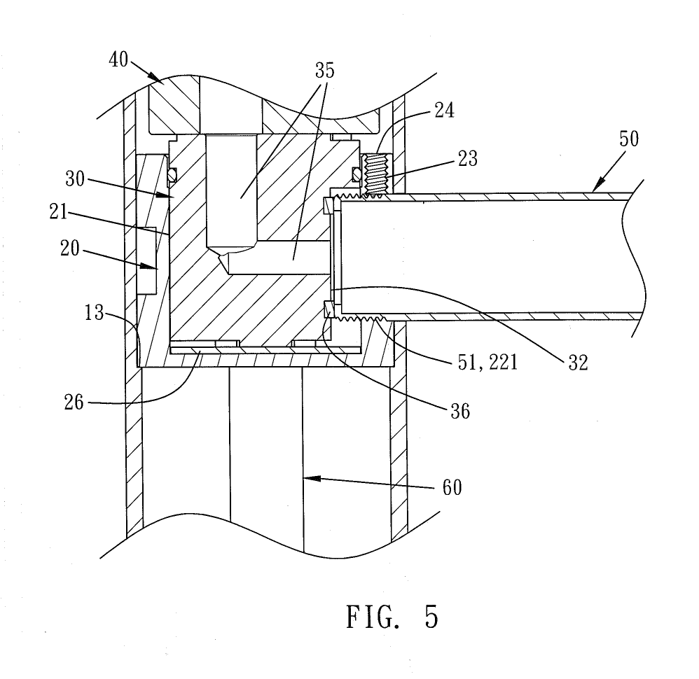

With reference to FIGS. 1-5, a connecting structure of a faucet body and a control valve according to a first embodiment of the present invention comprises:

a faucet body 10 stamped and welded from a metal piece and formed in a hollow tube shape, the faucet body 10 including a first segment 11, a second segment 12 relative to the first segment 11, a positioning rim 13 defined on an inner wall thereof between the first segment 11 and the second segment 12, a receiving space 14 formed between the positioning rim 13 and the first segment 11, and a connecting hole 15 formed on an outer wall thereof and communicating with the receiving space 14;

a fixing cylinder 20 fitted into the receiving space 14 from the first segment 11 of the faucet body 10 and retaining with the positioning rim 13, the fixing cylinder 20 including a circular cavity 21 in which an opening is defined and facing to the first segment 11 of the faucet body 10, an orifice 22 with inner threads 221 defined on an outer wall thereof and communicating with the connecting hole 15 of the faucet body 10, a threaded hole 23 formed on a top surface thereof so as to screw with a screw bolt 24 and passing through the orifice 22, two apertures 25 arranged on a bottom end thereof so as to insert two inlet pipes 60, and a stopping member 26 fixed on a bottom end of the circular cavity 21 of the fixing cylinder 20;

a guiding seat 30 disposed in the circular cavity 21 of the fixing cylinder 20 and including a seal ring 31 fitted on an upper side of an outer wall thereof and abutting against an inner wall of the fixing cylinder 20, a tangent face 32 defined on the outer wall thereof and corresponding to the orifice 22 of the fixing cylinder 20 and the connecting hole 15 of the faucet body 10, two grooves 33 defined on a top surface thereof, two inlets 34 passing downwardly therealong and having two lower ends which connect with the two inlet pipes 60, an outlet 35 extending toward the tangent face 32 and a sealing loop 36 fitted on the tangent face 32 and around the outlet 35;

a control valve 40 inserted into the receiving space 14 from the first segment 11 of the faucet 10 and locking with a nut 70 so that a bottom end of the control valve 40 is biased against the guiding seat 30;

an outlet pipe 50 including a screwing section 51 mounted on one end thereof and screwing with screw bolt 24 of the fixing cylinder 20 via the inner threads 221 of the orifice 22 of the fixing cylinder 20 and the connecting hole 15 of the faucet body 10 so as to position the outlet pipe 50, such that the one end of the outlet pipe 50 on which the screwing section 51 is mounted, contacts with the sealing loop 36 of the tangent face 32 of the guiding seat 30, thus closing a water flow.

In operation, a rod of the control valve 40 is rotated so that a cold water and a hot water flow into the control valve 40 via the two inlets 34 from the two inlet pipes 60, hence a mixing rate and a flow amount of the cold water and the hot water are adjusted by ways of the control valve 40, then the water flow mixed from the cold water and the hot water flows into the outlet pipe 50 from the outlet 35 of the guiding seat 30.

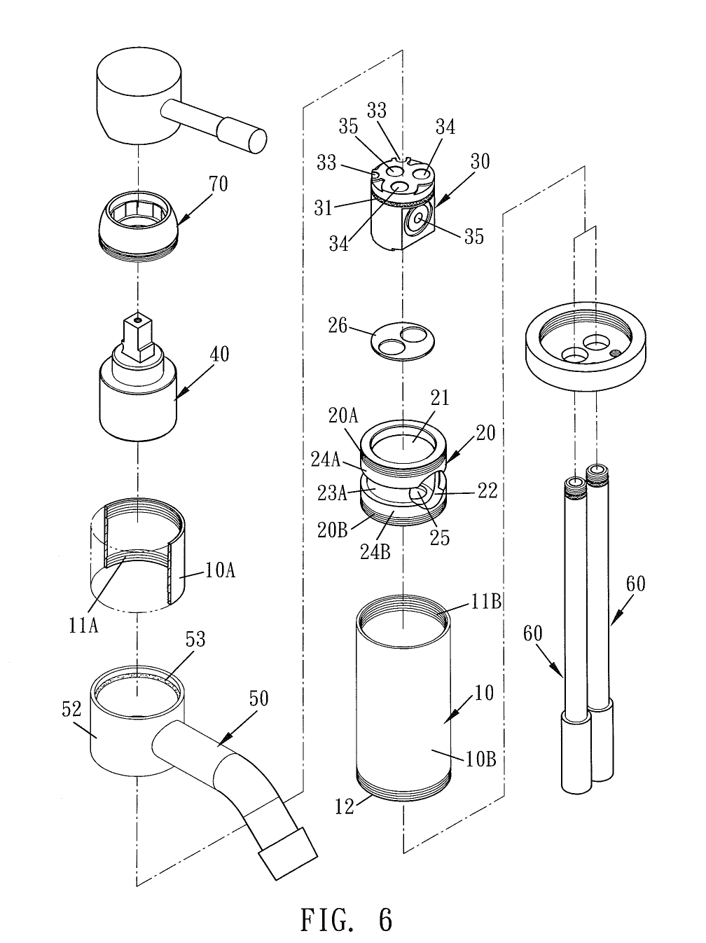

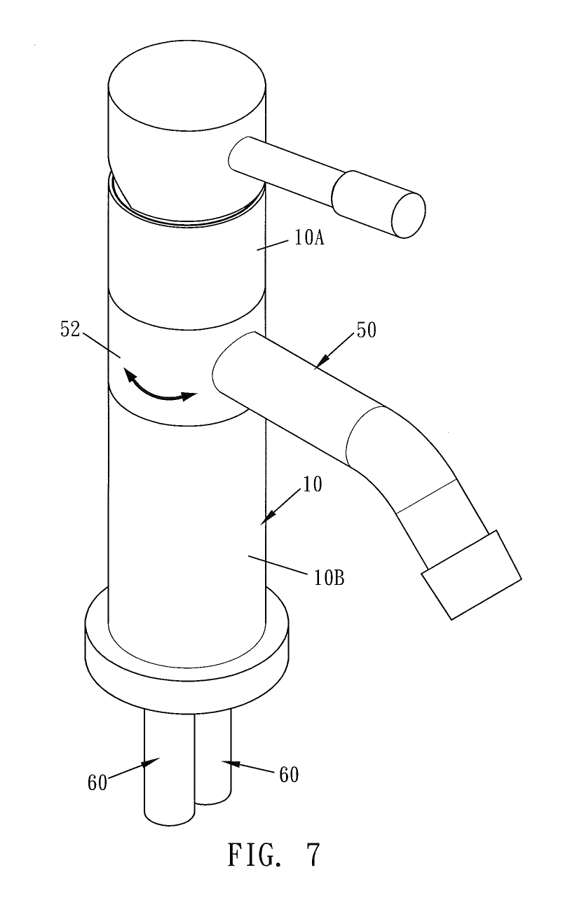

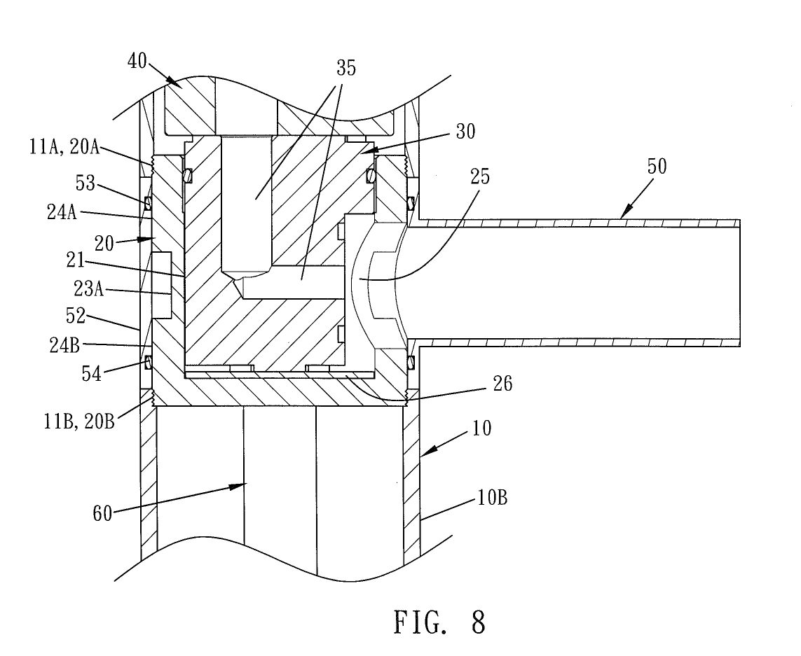

Referring further to FIGS. 6-8, a connecting structure of a faucet body and a control valve according to a second embodiment of the present invention comprises:

a faucet body 10 stamped and welded from a metal piece and formed in a hollow tube shape, the faucet body 10 including a first tube part 10A and a second tube part 10B, the first tube part 10A having first inner threads 11A defined on an inner wall of one end thereof, and the second tube part 10B having second inner threads 11B formed on an inner wall of one end thereof;

a fixing cylinder 20 being circular and including first outer threads 20A formed around an upper peripheral side of an outer wall thereof and screwing with first inner threads 11A of the first tube part 10A of the faucet body 10, second outer threads 20B formed around an lower peripheral side of the outer wall thereof and screwing with second inner threads 11B of the second tube part 10B of the faucet body 10, such that the first tube part 10A and the second tube part 10B of the faucet body 10 are connected together by means of the fixing cylinder 20, the fixing cylinder 20 also including a circular cavity 21 in which an opening is defined and facing upwardly, an orifice 22 defined on an outer wall thereof and communicating with the circular cavity 21, a slot 23A formed around a middle section of the outer wall thereof and communicating with the orifice 22, a first retaining face 24A and a second retaining face 24B defined among the slot 23A, the first outer threads 20A, and the second outer threads 20B, two apertures 25 arranged on a bottom end thereof so as to insert two inlet pipes 60, and a stopping member 26 fixed on a bottom end of the circular cavity 21 of the fixing cylinder 20;

a guiding seat 30 disposed in the circular cavity 21 of the fixing cylinder 20 and including a seal ring 31 fitted on an upper side of an outer wall thereof and abutting against an inner wall of the fixing cylinder 20, two grooves 33 defined on a top surface thereof, two inlets 34 passing downwardly therealong, and an outlet 35 extending toward the outer wall thereof, two lower ends of the two inlets 32 coupling with the two inlet pipes 60 via the bottom end of the fixing cylinder 20;

a control valve 40 inserted into the second tube part 10B of the faucet body 10 and locking with a nut 70 so that a bottom end of the control valve 40 is biased against the guiding seat 30;

an outlet pipe 50 including one segment coupling with a circular fitting member 52 which is rotatably fitted on the fixing cylinder 20, such that the outlet pipe 50 movably rotates so as to communicate with the outlet 35 of the guiding seat 30 through the orifice 22 and the slot 23A of the fixing cylinder 20, and the fitting member 52 having a first anti-leak ring 53 mounted on an upper side of an inner wall thereof and retaining with the first retaining face 24A of the fixing cylinder 20, and a second anti-leak ring 54 mounted on a lower side of the inner wall thereof and retaining with the second retaining face 24B of the fixing cylinder 20, thus closing a water flow.

In operation, a rod of the control valve 40 is rotated so that a cold water and a hot water flow into the control valve 40 via the two inlets 34 from the two inlet pipes 60, hence a mixing rate and a flow amount of the cold water and the hot water are adjusted by ways of the control valve 40, then the water flow mixed from the cold water and the hot water flows into the outlet pipe 50 from the outlet 35 of the guiding seat 30, and the outlet pipe 50 movably rotates to any desired angle.

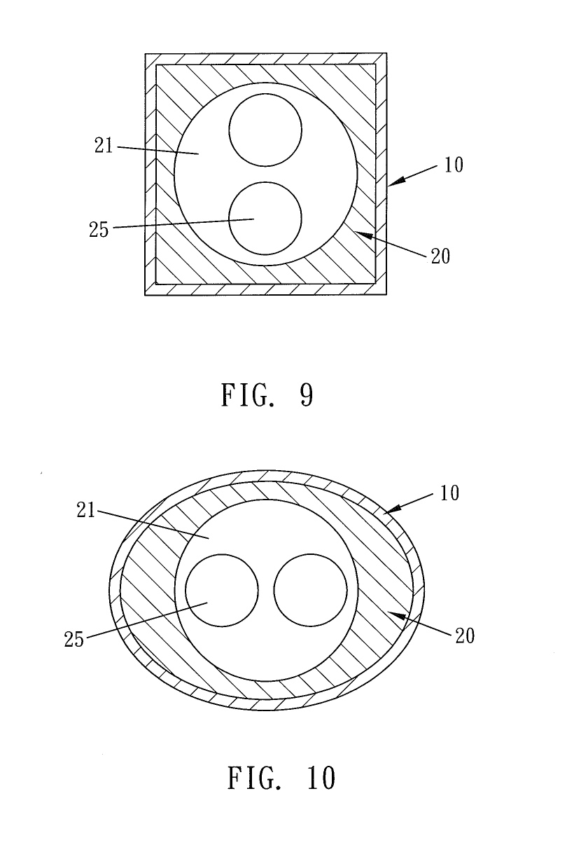

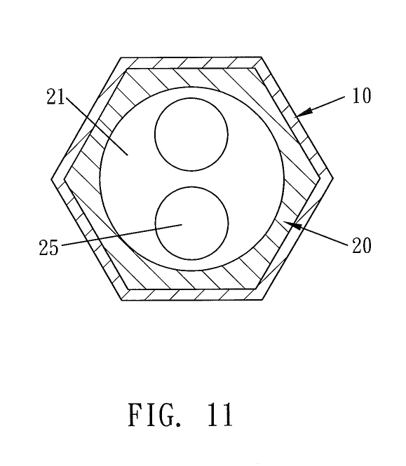

In addition, a faucet body 10 of a third embodiment of the present invention is square as shown in FIG. 9; a faucet body 10 of a fourth embodiment of the present invention is oval as illustrated in FIG. 10; a faucet body 10 of a fifth embodiment of the present invention is hexagonal as shown in FIG. 11. The faucet body 10 is also formed in a geometry shape. Thereby, a shape of the faucet body 10 corresponds to that of the fixing cylinder 20 (such as a square shape, an oval shape, a hexagonal shape, or a geometrical shape), and a fixing cylinder 20 of the third embodiment, the fourth embodiment, and the fifth embodiment includes a circular cavity 21 defined therein and two apertures 25 defined in a bottom end thereof so as to insert two inlet pipes 60 via the bottom end of the fixing cylinder 20.

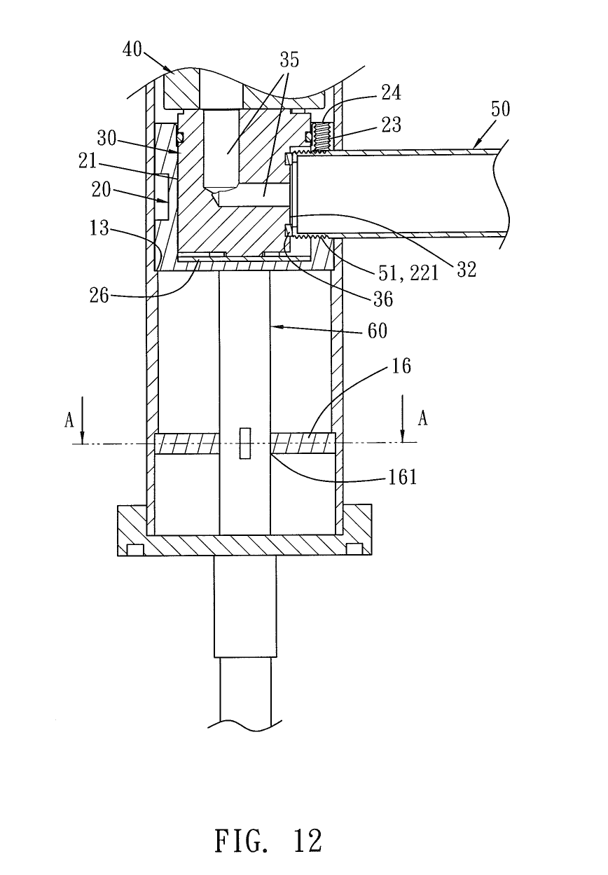

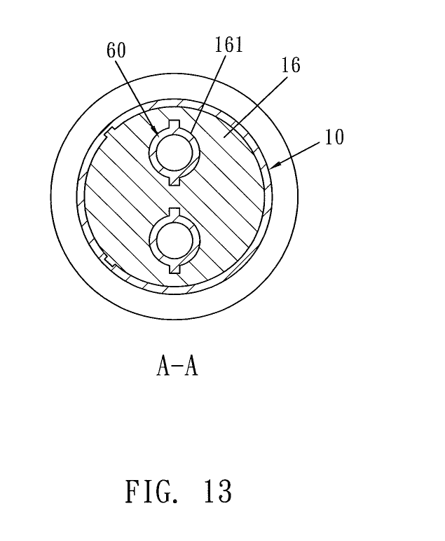

As shown in FIGS. 12 and 13, the faucet body 10 includes a locking piece 16 retained with the inner wall thereof, and the locking piece 16 has two pores 161 defined therein so as to insert and lock the two inlet pipes 60.

Thereby, the connecting structure of the faucet body and the control valve of the present invention has the following advantages:

1. The faucet body 10 is stamped and welded from the metal piece and is formed in a hollow tube shape so as to match with the fixing cylinder 20 including the circular cavity 21, such that the guiding seat 30 and the control valve 40 are fixed in the faucet body 10, and the shape of the faucet body 10 is geometrical and variable, thus increasing aesthetics appearance.

2. The faucet body 10 is stamped and welded from the metal piece and is formed in a hollow tube shape so as to match with the fixing cylinder 20 including the circular cavity 21, such that the guiding seat 30 and the control valve 40 are fixed in the faucet body 10, so an interior of the faucet body 10 need not be worked precisely, thus accelerating working process and lowering material and production costs.

While we have shown and described various embodiments in accordance with the present invention, it is clear to those skilled in the art that further embodiments may be made without departing from the scope of the present invention.

What is claimed is:

1. A connecting structure of a faucet body and a control valve comprising:
a faucet body stamped and welded from a metal piece and formed in a hollow tube shape, the faucet body including a first segment, a second segment relative to the first segment, a positioning rim defined on an inner wall thereof between the first segment and the second segment, and a receiving space formed between the positioning rim and the first segment;
a fixing cylinder formed in a shape corresponding to a shape of an interior of the faucet body, the fixing cylinder being fitted into the receiving space from the first segment of the faucet body and retaining with the positioning rim and including a circular cavity, an orifice defined on an outer wall thereof and communicating with the circular cavity, and two apertures arranged on a bottom end thereof so as to insert two inlet pipes;
a guiding seat disposed in the circular cavity of the fixing cylinder and including two grooves defined on a top surface thereof, two inlets passing downwardly therealong and having two lower ends which connect with the two inlet pipes of the fixing cylinder;
a control valve inserted into the receiving space from the first segment of the faucet body, and a bottom end of the control valve being biased against the guiding seat;
an outlet pipe coupling with the faucet body and communicating with the outlet of the guiding seat.

2. The connecting structure of the faucet body and the control valve as claimed in claim 1, wherein the faucet body also includes a connecting hole formed on the outer wall thereof so as to connect with a screwing section of the outlet pipe and connecting the receiving space of the faucet body.

3. The connecting structure of the faucet body and the control valve as claimed in claim 2, wherein the orifice of the fixing cylinder has inner threads, the outlet pipe includes the screwing section mounted on one end thereof and screwing with the inner threads of the orifice of the fixing cylinder via the connecting hole of the faucet body.

4. The connecting structure of the faucet body and the control valve as claimed in claim 1, wherein the fixing cylinder also includes a threaded hole formed on a top surface thereof so as to screw with the screw bolt and passing through the orifice.

5. The connecting structure of the faucet body and the control valve as claimed in claim 1, wherein the circular cavity of the fixing cylinder has a stopping member fixed on a bottom end thereof.

6. The connecting structure of the faucet body and the control valve as claimed in claim 1, wherein the guiding seat including a seal ring fitted on an upper side of an outer wall thereof and abutting against an inner wall of the fixing cylinder.

7. The connecting structure of the faucet body and the control valve as claimed in claim 1, wherein the guiding seat includes a tangent face defined on the outer wall thereof and corresponding to the orifice of the fixing cylinder, a sealing loop fitted on the tangent face and around the outlet, such that the one end of the outlet pipe, on which the screwing section is mounted, contacts with the sealing loop of the tangent face, thus closing a water flow.

8. A connecting structure of a faucet body and a control valve comprising:
a faucet body stamped and welded from a metal piece and formed in a hollow tube shape, the faucet body including a first tube part and a second tube part;
a fixing cylinder being circular and including an upper end connecting with the first tube part of the faucet body and a lower end coupling with second the second tube part of the faucet body, such that the first tube part and the second tube part of the faucet body are connected together by means of the fixing cylinder, the fixing cylinder also including a circular cavity, an orifice defined on an outer wall thereof and communicating with the circular cavity, a slot formed around a middle section of the outer wall thereof and communicating with the orifice, two apertures arranged on a bottom end thereof so as to insert two inlet pipes;
a guiding seat disposed in the circular cavity of the fixing cylinder and including two grooves defined on a top surface thereof, two inlets passing downwardly therealong, and an outlet extending toward the outer wall thereof, two lower ends of the two inlets coupling with the two inlet pipes;
a control valve inserted into the second tube part of the faucet body and including a bottom end biased against the guiding seat;
an outlet pipe including one segment coupling with a circular fitting member which is rotatably fitted on the fixing cylinder, such that the outlet pipe movably rotates so as to communicate with the outlet of the guiding seat through the orifice and the slot of the fixing cylinder.

9. The connecting structure of the faucet body and the control valve as claimed in claim 8, wherein the first tube part has first inner threads defined on an inner wall of one end thereof, and the second tube part has second inner threads formed on an inner wall of one end thereof; the fixing cylinder includes first outer threads formed around an upper peripheral side of an outer wall thereof and screwing with first inner threads, second outer threads formed around an lower peripheral side of the outer wall thereof and screwing with second inner threads of the second tube part of the faucet body.

10. The connecting structure of the faucet body and the control valve as claimed in claim 8, wherein a first retaining face and a second retaining face are defined among the slot, the first outer threads, and the second outer threads, the fitting member has a first anti-leak ring mounted on an upper side of an inner wall thereof and retaining with the first retaining face of the fixing cylinder, and a second anti-leak ring mounted on a lower side of the inner wall thereof and retaining with the second retaining face of the fixing cylinder, thus closing a water flow.

11. The connecting structure of the faucet body and the control valve as claimed in claim 8, wherein the circular cavity of the fixing cylinder has a stopping member fixed on a bottom end thereof.

12. The connecting structure of the faucet body and the control valve as claimed in claim 8, wherein the guiding seat includes a seal ring fitted on an upper side of an outer wall thereof and abutting against an inner wall of the fixing cylinder.
